(19) United States
(12) Patent Application Publication
(10) Pub. No.: US 2011/0176705 A1
(43) Pub. Date: Jul. 21, 2011

(54) Information processing device, information processing system and program

(75) Inventor: Shinichi Kato, Tokyo (JP)

(73) Assignee: FeliCa Networks, Inc., Tokyo (JP)

(21) Appl. No.: 12/930,577

(22) Filed: Jan. 11, 2011

(30) Foreign Application Priority Data
Jan. 19, 2010 (JP) P2010-009455

(51) Int. Cl. G06K 9/00

(52) U.S. Cl. 382/100

(57) ABSTRACT

An information processing device of present invention includes an identification medium detecting portion that detects a specific identification medium, a position acquisition portion that acquires information indicating a positional relationship between the identification medium and the information processing device, a processing execution portion that executes specific processing when the information processing device is at a distance from the identification medium that is equal to or less than a predetermined value, and a processing execution prevention portion that causes the specific processing not to be performed by the processing execution portion when the information processing device is at a distance from the identification medium that is equal to or less than the predetermined value immediately after an application relating to the specific processing is activated.

### BACKGROUND OF THE INVENTION

1. Field of the Invention

The present invention relates to an information processing device, an information processing system and a program.

2. Description of the Related Art

In known art, a technique is known that realizes a visual effect by merging a real space and a virtual space, as disclosed, for example, in Japanese Patent Application Publication No. JP-A-2000-322602.

### SUMMARY OF THE INVENTION

The technology disclosed in Japanese Patent Application Publication No. JP-A-2000-322602 can detect a two-dimensional (2D) barcode from a captured image and can display this superimposed on a three-dimensional (3D) image of a captured object that corresponds to the 2D barcode, thus realizing a visual effect in which a real space and a virtual space are merged. However, this technology does not assume further development of the visual effect in which some kind of processing is performed using an identification marker, such as a 2D barcode and the like.

In light of the foregoing, it is desirable to provide a novel and improved information processing device, information processing system and program, which are capable of recognizing an identification marker and causing specific processing to be performed based on the identification marker, while allowing significant reductions in the configuration of hardware relating to the system.

According to an embodiment of the present invention, there is provided an information processing device includes an identification medium detecting portion that detects a specific identification medium, a position acquisition portion that acquires information indicating a positional relationship between the identification medium and the information processing device, a processing execution portion that executes specific processing when the information processing device is at a distance from the identification medium that is equal to or less than a predetermined value, and a processing execution prevention portion that causes the specific processing not to be performed by the processing execution portion when the information processing device is at a distance from the identification medium that is equal to or less than the predetermined value immediately after an application relating to the specific processing is activated.

In this configuration, the information processing device further includes an own device position information acquisition portion that acquires position information of the information processing device. The processing execution portion determines whether to execute the specific processing based on position information included in the identification medium and on the position information of the information processing device.

In this configuration, the processing execution portion performs the specific processing in one of a case in which the information processing device is at a distance from the identification medium that is equal to or less than the predetermined value and a case in which a separate medium is at a distance from the identification medium that is equal to or less than a predetermined value.

In this configuration, the position acquisition portion includes a function to acquire a relative orientation of the information processing device with respect to the identification medium, and the processing execution portion executes the specific processing when the relative orientation of the information processing device with respect to the identification medium is equal to or less than a predetermined angle range, taking as a reference a state in which the information processing device is correctly facing the identification medium.

In this configuration, the information processing device further including an image pickup portion that acquires an image. The identification medium detecting portion detects the identification medium from the image acquired by the image pickup portion, and the position acquisition portion acquires the information indicating the positional relationship between the identification medium and the information processing device based on the image of the identification medium acquired by the image pickup portion.

In this configuration, the identification medium is a two-dimensional barcode.

In this configuration, the information processing device further includes a virtual object merging portion that merges a virtual object generated based on the identification medium acquired by the image pickup portion with the image; and a display portion that displays the merged image, in which the virtual object is merged with the image acquired by the image pickup portion.

In this configuration, the identification medium detecting portion detects the identification medium by one of character recognition, near field wireless communication and optical communication.

In this configuration, the specific processing is one of payment processing relating to an object to which the identification medium is attached and payment processing relating to a store in which the identification medium is placed.

In this configuration, the information processing device further includes a payment processing notification portion that outputs one of image and audio when the payment processing is performed.

In this configuration, the information processing device further includes an IC chip that stores electronic value information relating to the payment processing.

According to another embodiment of the present invention, there is provided an information processing system includes an information processing device and a payment server. The information processing device includes an identification medium detecting portion that detects a specific identification medium, a position acquisition portion that acquires information indicating a positional relationship between the identification medium and the information processing device, a processing request portion that, when the information processing device is at a distance from the identification medium that is equal to or less than a predetermined value, transmits identification information of the information processing device and information of the identification medium and requests to perform payment processing, and a processing execution prevention portion that causes the processing request not to be performed by the processing request portion when the information processing device is at a distance from the identification medium that is equal to or less than the predetermined value immediately after an application relating to the payment processing is activated. The payment server that receives the request to perform the payment processing from the information processing device, and executes the payment processing when the identification medium is registered by a store to which the payment is performed.

In this configuration, the information processing system further includes a store terminal that, when the payment processing is executed, receives identification information of the information processing device from the payment server and also receives identification information of a product relating to payment that is included in the identification medium; and a gate that is installed in the store, and that acquires the identification information of the product and the identification information of the information processing device that are going to pass through the gate and transmits the acquired identification information to the store terminal, the gate only opening when the gate receives notification from the store terminal that the product is paid for.

According to another embodiment of the present invention, there is provided a storage medium storing a computer program includes instructions that command a computer to perform the steps of detecting a specific identification medium, acquiring information indicating a positional relationship between the identification medium and an information processing device, executing specific processing when the information processing device is at a distance from the identification medium that is equal to or less than a predetermined value, and preventing execution of the specific processing when the information processing device is at a distance from the identification medium that is equal to or less than the predetermined value immediately after activation of an application relating to the specific processing.

According to another embodiment of the present invention, there is provided an information processing method, includes the steps of detecting a specific identification medium, acquiring information indicating a positional relationship between the identification medium and an information processing device, executing specific processing when the information processing device is at a distance from the identification medium that is equal to or less than a predetermined value; and preventing execution of the specific processing when the information processing device is at a distance from the identification medium that is equal to or less than the predetermined value immediately after activation of an application relating to the specific processing.

According to the present invention described above, it is possible to recognize an identification marker and cause specific processing to be performed based on the identification marker, while allowing significant reductions in the configuration of hardware relating to the system.

### BRIEF DESCRIPTION OF THE DRAWINGS

FIG. 1 is a schematic diagram showing a state of performing electronic payment using an information processing device (a client terminal), such as a mobile telephone etc. with a built-in IC chip;

FIG. 2 is a schematic diagram showing a method of performing payment processing by a user inputting a credit card number, a PIN number etc. from the information processing device and accessing a payment server that is connected via a network;

FIG. 3 is a schematic diagram showing an example of a system configuration of a payment system according to an embodiment of the present invention;

FIG. 4 is a block diagram showing an example of a configuration of the information processing device;

FIG. 5 is a schematic diagram showing a configuration image of a barcode used in the payment system according to the present embodiment;

FIG. 6 is a sequence diagram illustrating a processing sequence of a system according to the present embodiment;

FIG. 7 is a flowchart illustrating processing by the information processing device in detail;

FIG. 8 is a schematic diagram showing a state displayed on a display portion in which CG of a virtual reader/writer is merged with an image captured by a camera portion; and

FIG. 9 is a schematic diagram showing a state in which a barcode representing “execute payment” is attached to a user's hand and displayed on a display portion 112 along with a barcode indicating the virtual reader/writer.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the order shown below.

1. Prerequisite technology

2. Example of system configuration of payment system according to present embodiment

3. Example of configuration of information processing device

4. Configuration image of barcode information

5. Processing sequence of system according to present embodiment

6. Processing by information processing device

7. Method of payment other than by information processing device coming close to barcode

### 1. Prerequisite Technology

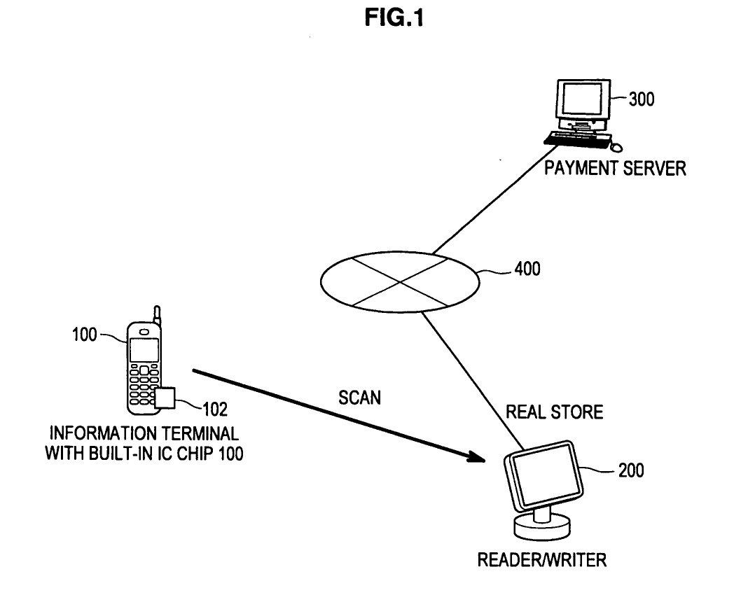

FIG. 1 is a schematic diagram showing a state of performing electronic payment using an information processing device (client terminal) 100, such as a mobile telephone or the like. In the configuration shown in FIG. 1, the information processing device 100 has a built-in chip, such as an IC chip 102. In addition, a reader/writer 200, which can read and write the IC chip 102, is installed in an actual store (real store). The reader/writer 200 is connected to a payment server 300 via a network 400, such as the Internet etc. Communication is performed between the IC chip 102 and the reader/writer 200 and payment processing is thus performed when a user causes the information processing device 100 to come into contact with the reader/writer 200, or when the user performs a movement such that information processing device 100 comes close to the reader/writer 200. The reader/writer 200 transmits payment data to the payment server 300 every day, for example. In this way, the real store can receive revenue from an operator of the payment server 300.

However, with the system shown in FIG. 1, it is necessary to set up the reader/writer 200 in the store, and to connect the reader/writer 200, via the network 400, to the payment server 300 that manages electronic payment results. This system therefore has the disadvantage that costs are incurred to set up (install) the reader/writer 200 in the real store. Furthermore, as significant costs are incurred in order to install the reader/writer 200, it is difficult to respond flexibly to increases or decreases in a number of the reader/writers 200, such as in response to a busy season. Additionally, as it is necessary to connect the reader/writer 200 to the network 400, it is also difficult to move an installation position of the reader/writer 200 and so on.

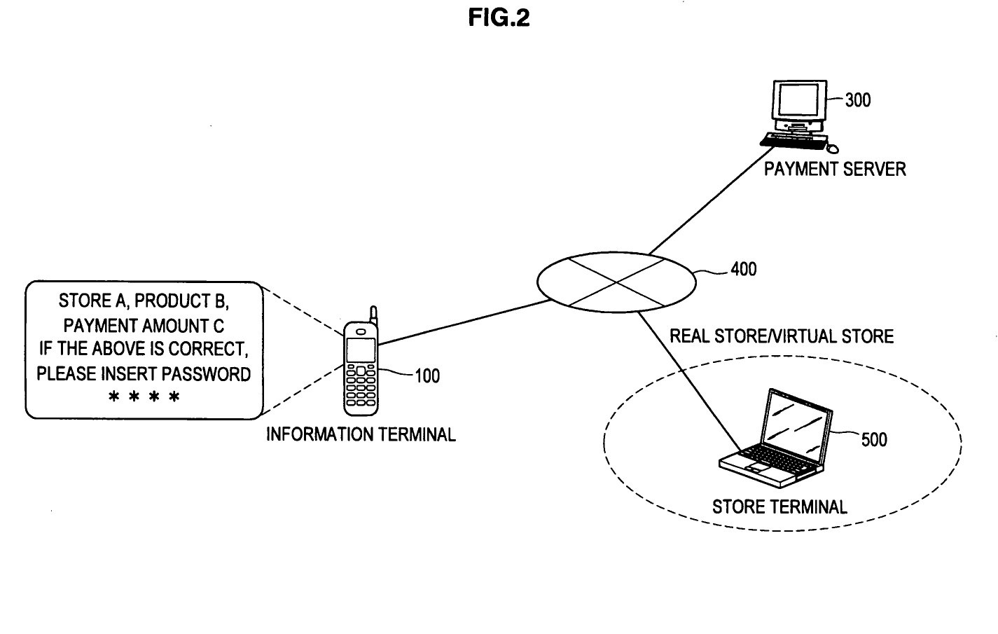

On the other hand, as shown in FIG. 2, there is a system in which payment processing is performed by the user inputting a credit card number, a PIN number etc. from the information processing device 100 and accessing the payment server 300 that is connected via the network 400. When the payment server 300 of a credit company or the like receives access from the information processing device 100 and performs payment processing, it performs the payment processing with a store terminal 500 of the real store (or of a virtual store) and the store obtains revenue from the operator of the payment server 300. In this type of electronic payment using a communication network, although it is not necessary to set up the reader/writer 200 and so on, it is necessary for the user to use the information processing device 100 to input or confirm the store to which the user wishes to make payment, the payment amount and so on, and also to input a password in order to avoid mistaken payment. As a result, it is necessary for the user to perform a troublesome operation.

Alternatively, there is a technology called augmented reality (AR) in which a picture created by computer graphics (CG) or a virtual object, such as a speech bubble or the like, is superimposed onto an image of a real space. Taking into account the disadvantages of the above-described systems, it is conceivable to perform electronic payment using a communication network, where the electronic payment is performed based on the information processing device 100 recognizing position information of the information processing device 100, determining the store to which payment for a product is to be made based on the position information, and further recognizing specific information that represents a virtual reader/writer using AR. More specifically, the information processing device 100 is equipped with a position detecting function, such as GPS, and, based on an assumption that a virtual reader/writer is installed in a specific location inside a store, settings are performed to cause the information processing device 100 to acquire the position of the virtual reader/writer. If the user carries the information processing device 100 to the specific position at which the virtual reader/writer is installed, the information processing device 100 recognizes by GPS that it is positioned at the specific position at which the virtual reader/writer is installed, and automatically performs payment. Then, a value corresponding to a payment amount is withdrawn from the IC chip 102. According to this system, it is possible to offer the user the same ease of use as when using the IC chip 102 illustrated by FIG. 1, without installing the real reader/writer 200. However, if the payment is performed only based on the position of the information processing device 100, if the information processing device 100 is coincidentally placed in the specific position at which payment becomes possible, it is possible that the payment may be made without any intention by the user.

Given the above-described points, in the present embodiment, the position of the virtual reader/writer is set by a 2D barcode, and payment is made after the information processing device 100 recognizes the virtual reader/writer and confirms that the position of the 2D barcode is appropriate, using a position detecting function such as GPS. Further, in the present embodiment, in order to prevent payment without the intention of the user, when the information processing device 100 comes close to the specific position at which the virtual reader/writer is installed, the proximity to the specific position is notified to the user by images and audio. In addition, if, immediately after activating an application relating to payment, or immediately after activating the information processing device 100, the information processing device 100 is coincidentally at the specific position at which the virtual type reader/writer 200 is installed, payment is not performed, in order to prevent mistaken payment. Furthermore, even when the information processing device 100 rapidly comes close to the specific position immediately after the information processing device 100 is activated and that is not recognized by the user, payment is not performed, thus preventing mistaken payment. Note that the term “immediately after activation” is not limited to being immediately after activation of the above-described application relating to payment or to being immediately after activation of the information processing device 100. For example, when a switch is separately provided on the information processing device 100 that sets a mode by which payment processing is performed based on an identification marker or on position information, “immediately after activation” includes immediately after the switch is turned on (ON), when the switch is off (OFF) immediately after activation of the information processing device 100. Additionally, if structural elements that will be explained later, such as a camera portion 110, a GPS receiving portion 104 and a near field communication portion 108, do not operate for some reason at first, “immediately after activation” also includes immediately after those structural elements finally become functional.

Note that this system is not limited to payment, and even in an application other than that of payment, this system can be applied to a system that starts some type of processing when the information processing device 100 is taken to a specific position at which a virtual device is installed. Even in an application other than that of payment, it is possible to prevent payment processing being performed without the intention of the user.

### 2. Example of System Configuration of Payment System According to Present Embodiment

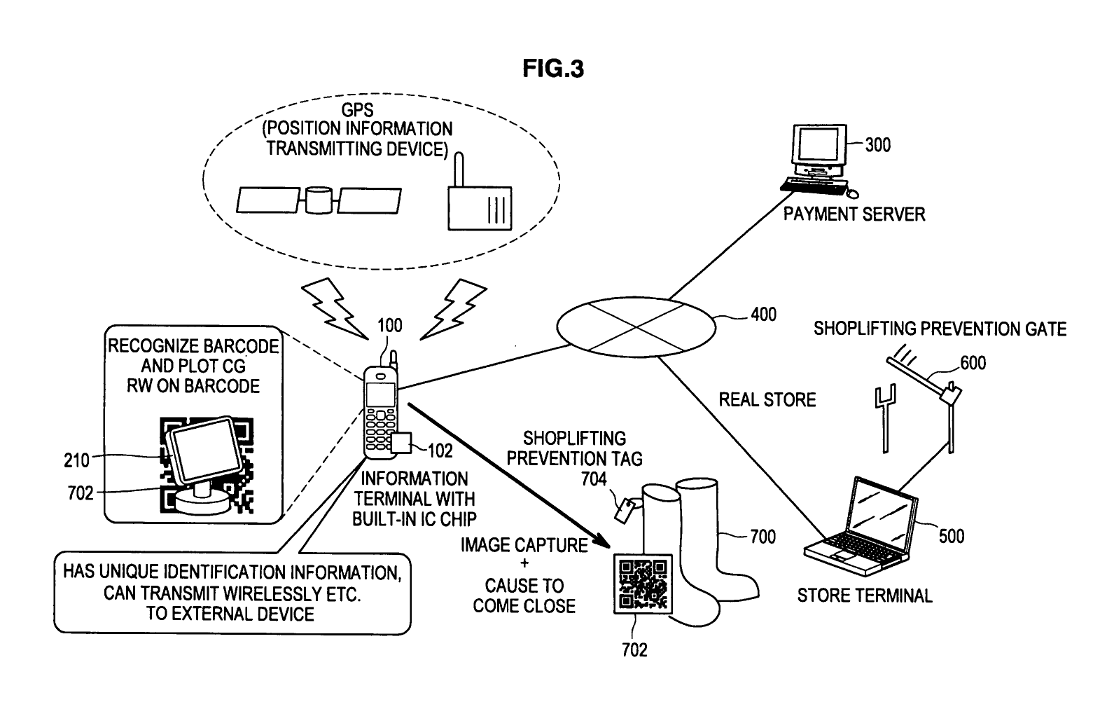

Hereinafter, a payment system according to the present embodiment will be explained in more detail. The system explained below also takes into account prevention of unauthorized removal of a product from a store (shoplifting). FIG. 3 is a schematic diagram showing an example of a system configuration of the payment system according to the present embodiment. The information processing device 100 is provided with the IC chip 102 that can perform payment by performing wireless communication with an external reader/writer. Here, the reader/writer includes the real reader/writer 200 and a virtual reader/writer 210 that is displayed on a display screen using computer graphics (CG) or the like. The virtual reader/writer 210 is recognized by the information processing device 100 detecting a barcode 702 that is attached to a product.

### 3. Example of Configuration of Information Processing Device

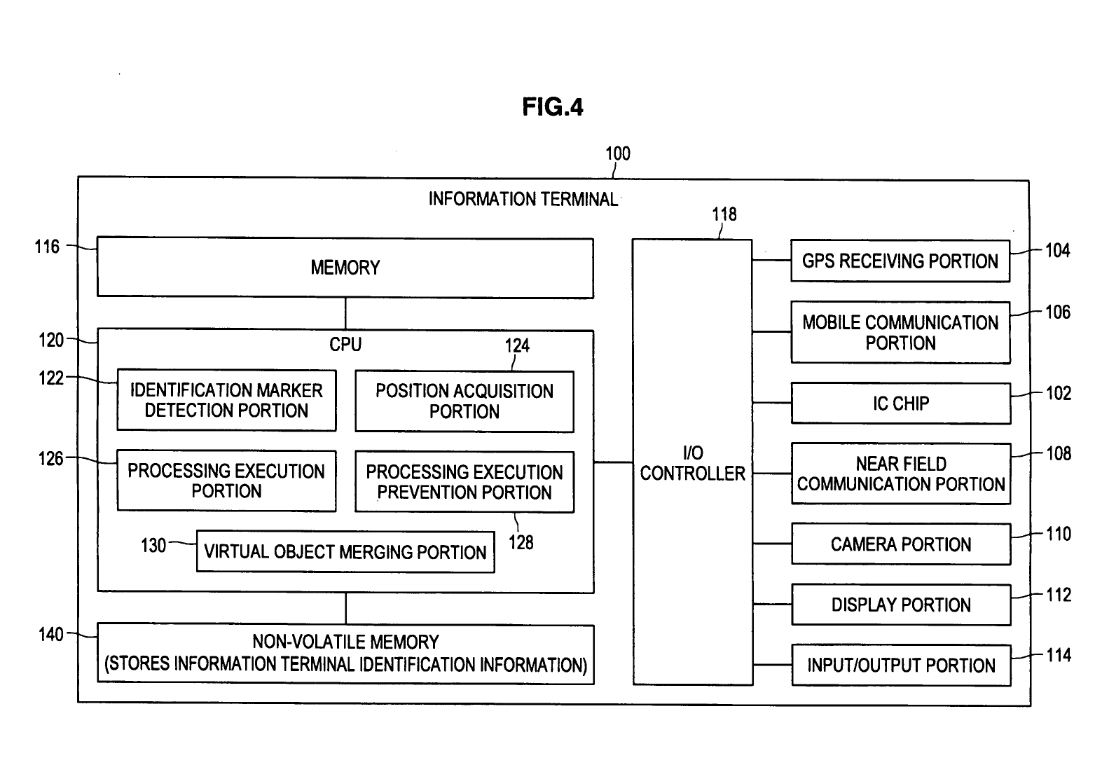

FIG. 4 is a block diagram showing an example of a configuration of the information processing device 100. As shown in FIG. 4, the information processing device 100 includes the GPS receiving portion 104, a mobile communication portion 106, the IC chip 102, the near field communication portion 108, the camera portion 110, a display portion 112, an input portion 114, a memory 116, an I/O controller 118, a CPU 120 and a non-volatile memory 140.

By the above-described configuration, the information processing device 100 is provided with a function by which it can recognize its own position based on radio waves transmitted from a position information transmitting device such as GPS or a wireless LAN access point. The information processing device 100 further has a camera function and an image processing function which can capture the barcode 702 using the camera portion 110 and verify the content of the barcode 702. The information processing device 100 also has a display function which can display, on the display portion 112, an image captured by the camera portion 110 or, when the barcode 702 is recognized, can plot and display CG of a virtual reader/writer superimposed on the barcode 702. The information processing device 100 further has a transmission function which can hold identification information that is unique to the information processing device 100 and wirelessly transmit the identification information to an external device. Note that the I/O controller 118 is a controller that intervenes between the blocks, such as the CPU 120 and the GPS receiving portion 104, and the mobile communication portion 106 is a functional portion of a mobile telephone.

The CPU 120 of the information processing device 100 has a function to control each of the structural elements shown in FIG. 4. Information obtained by each of the structural elements shown in FIG. 4 is transmitted to the CPU 120, and the CPU 120 controls each of the structural elements based on these pieces of information. More specifically, the CPU 120 is provided with an identification marker detecting portion 122 that detects the barcode 702 (identification marker) based on an image captured by the camera portion 110, the barcode 702 being attached to a product 700. In addition, the CPU 120 is provided with a position acquisition portion 124 that acquires a positional relationship with the detected barcode 702, and a processing execution portion 126 that performs payment processing when a position and orientation with respect to the barcode 702 satisfy predetermined conditions. The CPU 120 is further provided with a processing execution prevention portion 128 that prevents the payment processing when the position and orientation with respect to the barcode 702 satisfy the predetermined conditions immediately after activation, and is also provided with a virtual object merging portion 130, which merges CG of the virtual object (the virtual reader/writer 210) with the detected barcode 702 and causes this to be displayed on the display portion 112 along with the captured image. At this time, the virtual object is stored in the memory 116 or in the non-volatile memory 140. Further, the identification information of the information processing device 100 is stored in the non-volatile memory 140. Note that each of the functional blocks shown in FIG. 4 can be formed of hardware (circuits) or of the CPU 120 and software (programs) that cause the CPU 120 to function. When formed by software, the programs can be stored in the memory 116, the non-volatile memory 140 or in an external storage medium etc.

It should also be noted that although, in the present embodiment, the payment processing is described as an example of processing that is performed when the position and orientation of the information processing device 100 with respect to the barcode 702 satisfy the predetermined conditions, the processing performed is not limited to this example. The present embodiment can be applied to various types of processing that are performed using the information processing device 100. Furthermore, the barcode 702 has been used to exemplify the identification marker, but character recognition, near field wireless communication, optical communication and the like may be used to detect a position with respect to the identification marker that has been attached to the product. When using character recognition, character recognition is performed based on an image of characters obtained by the camera portion 110. When near field wireless communication or optical communication is used, the near field communication portion 108 of the information processing device 100 detects the position with respect to the identification marker.

As shown in FIG. 3, the information processing device 100, the payment server 300 and the store terminal 500 are mutually connected via the network 400. The store terminal 500 is further connected to a shoplifting prevention gate (a product removal prevention gate) 600 of the store. Note that the shoplifting prevention gate 600 has a function to acquire the identification information from the information processing device 100 by near field wireless communication or the like, similarly to an automatic ticket gate installed at a railway station. Note also that the IC chip 102 and the payment server 300 mutually share an encryption key and have a function to allow exchange of payment information without this becoming known to a third party.

The barcode 702, which is recognized by the information processing device 100 and a shoplifting prevention tag (a product removal prevention tag) 704, which is recognized by the shoplifting prevention gate 600, are attached to the product 700 of the store. The shoplifting prevention tag 704 is recognized by the shoplifting prevention gate 600 in order to perform opening and closing of the shoplifting prevention gate 600. The shoplifting prevention tag 704 includes product ID information.

### 4. Configuration Image of Barcode Information

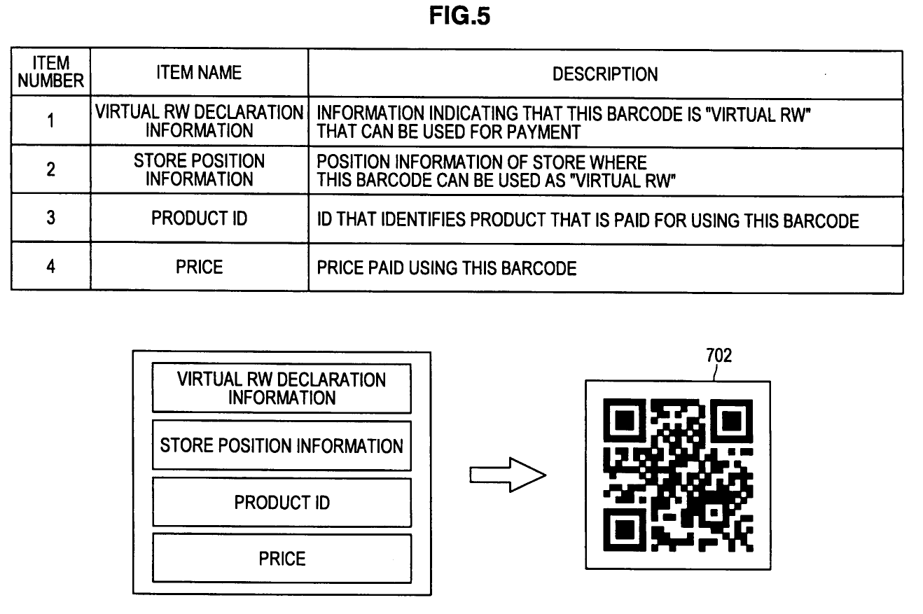

FIG. 5 is a schematic diagram showing a configuration image of the 2D barcode 702 that is used in the payment system according to the present embodiment. The barcode 702 includes virtual reader/writer (R/W) declaration information, store position information, product ID information, and product electronic value information. The product ID information and the electronic value information differ for each product to which the barcode 702 is attached, even within the same store.

The virtual reader/writer (R/W) declaration information is information that declares that the barcode 702 functions as a virtual reader/writer. When the barcode 702 is captured by the camera portion 110 of the information processing device 100, the information processing device 100 reads the virtual reader/writer (R/W) declaration information and displays CG of the virtual reader/writer superimposed on the barcode 702 that is displayed on the display portion 112.

The store position information is position information of the store in which the product to which the barcode 702 is attached is placed. When the camera portion 110 of the information processing device 100 captures the barcode 702, the information processing device 100 reads the store position information and compares position information obtained by GPS with the store position information of the barcode 702. If the position information obtained by GPS and the store position information of the barcode 702 are significantly different, the information processing device 100 can determine that the barcode 702 is not authentic, and can stop payment by the virtual reader/writer 210.

The product ID information is an ID (identification information) to identify the product to which the barcode 702 is attached. Further, the electronic value information is information indicating a price of the product to which the barcode 702 is attached. Based on the ID and electronic value information, the information processing device 100 can acquire information about the type of the product, the name of the product, the price of the product and so on.

### 5. Processing Sequence of System According to Present Embodiment

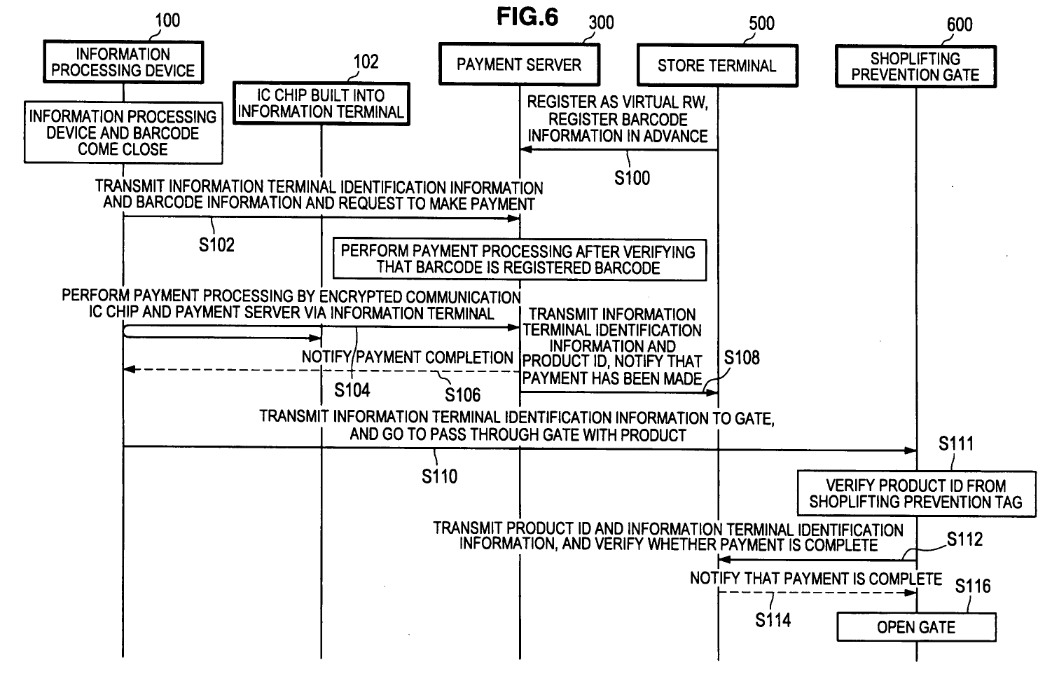

Next, a processing sequence of the system according to the present embodiment will be explained with reference to FIG. 6. First, in the real store, preparations are made to use the system. In the real store, the store terminal 500 is used to generate the barcode 702 which has the function to operate as the virtual reader/writer and which is attached to a product, and to register the information of the barcode 702 in the payment server 300 (step S100). The barcode 702 is attached to the product 700. The barcode 702 can be attached not only to a product but can be located in a chosen position within in the store, or can be attached to a wide variety of objects relating to services.

When the user causes the information processing device 100 to come close to the barcode 702 of the product 700 that the user wishes to pay for, the camera portion 110 of the information processing device 100 captures the barcode 702 and each piece of information on the barcode 702 is acquired by the identification marker detecting portion 122 of the CPU 120. The information processing device 100 transmits its own identification information and the information of the barcode 702 to the payment server 300, and requests to make payment (step S102). Note that processing performed when the information processing device 100 requests to make payment will be described in more detail later.

The payment server 300 first verifies that the transmitted barcode information matches barcode information registered by the store, and then performs encrypted communication with the IC chip 102 to perform the payment processing using the price included in the barcode information (step S104). If the position information included in the barcode 702 does not match the position information registered at step S100, the payment processing is not performed. Thus, if the barcode 702 is not placed in the correct store position, it is possible to prevent the payment processing from being performed using the unauthentic barcode 702. Then, the payment server 300 notifies the information processing device 100 of payment completion (step S106).

The payment server 300 transmits the identification information of the information processing device 100 that has performed payment and the product ID to the store terminal 500, and notifies that payment has been made (step S108).

Next, operation of the shoplifting prevention gate 600 will be explained. When payment is complete, in order to leave the store, the user goes to pass through the shoplifting prevention gate 600 while carrying the product 700. At that time, the information processing device 100 automatically transmits, to the shoplifting prevention gate 600, the identification information of the information processing device 100 (step S110). The identification information of the information processing device 100 may be transmitted to the shoplifting prevention gate 600 by an operation by the user.

The shoplifting prevention gate 600 recognizes, from the shoplifting prevention tag 704 that is attached to the product 700, the product ID that is to pass through the shoplifting prevention gate 600 (step S111). Then, along with the received identification information of the information processing device 100, the shoplifting prevention gate 600 confirms, with the store terminal 500, whether or not payment is complete for the product of the product ID recognized by the information processing device 100 that is going to pass through the shoplifting prevention gate 600 (step S112).

Based on the identification information of the information processing device 100 and the product ID information notified from the payment server 300 at step S108, the store terminal 500 notifies the shoplifting prevention gate 600 that “payment is complete” (step S114). When the shoplifting prevention gate 600 has been notified that “payment is complete”, it causes the gate to open and allows the user to pass through (step S116).

When the product has not been paid for, this means that a combination of the identification information of the information processing device 100 that is trying to pass through and the product ID does not exist in payment records in the store terminal 500. As a result, the store terminal 500 issues a notification at step S114 that the product is “not paid for.” In this case, the shoplifting prevention gate 600 does not open and the user cannot leave the store. It is thus possible to prevent the unpaid for product being removed from the store.

### 6. Processing by Information Processing Device

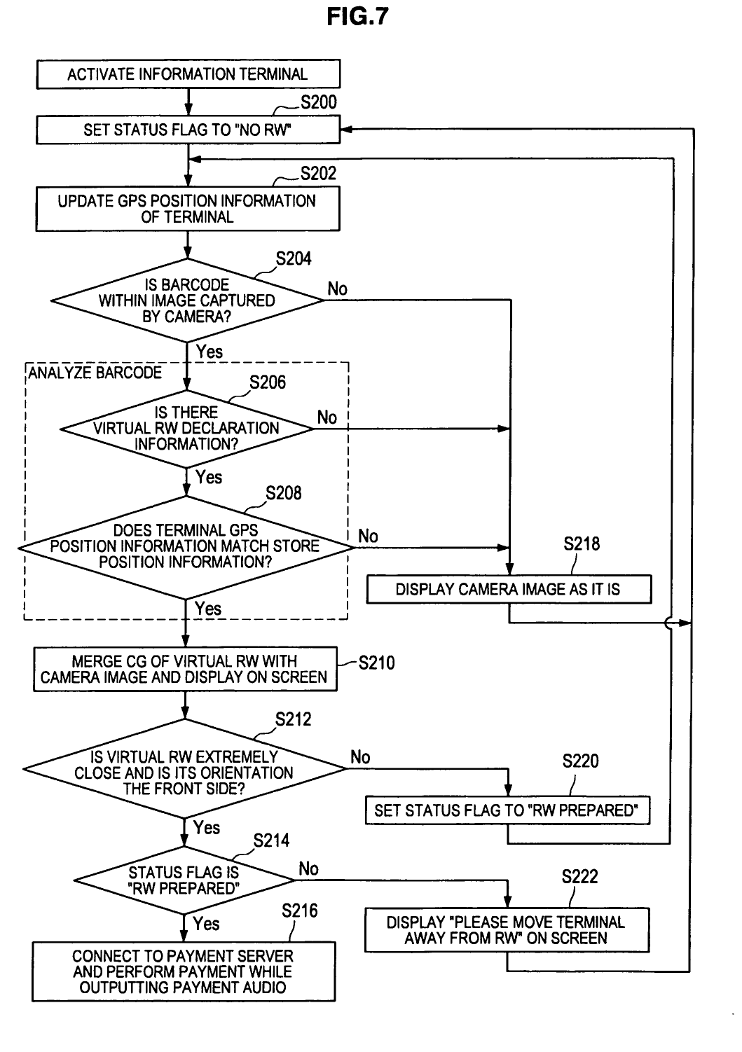

Next, processing by the information processing device 100 will be explained in detail with reference to FIG. 7. The information processing device 100 stores a “status flag” internally, and immediately after activation, the status flag is set to “No RW” (step S200). Then, the information processing device 100 acquires position information using the GPS receiving portion 104 and updates the position information (step S202). Following this, the identification marker detecting portion 122 determines whether or not the barcode 702 is present within an image captured by the camera portion 110 (step S204). If the barcode 702 is recognized within the image, the content of the barcode 702 is analyzed (step S206 and step S208).

At step S206, it is determined whether or not the virtual RW declaration information is included in the barcode 702. When the virtual RW declaration information is included in the barcode 702, it is determined whether or not the position information of the information processing device 100 received by the GPS receiving portion 104 matches the store position information acquired from the barcode 702 (step S208). When the position information of the information processing device 100 matches the store position information, this means that the barcode 702 is correctly placed in the store that generated the barcode 702. The information processing device 100 therefore merges CG of the virtual reader/writer 210 with the image captured by the camera portion 110 and displays the merged image on the screen (step S210). It should be noted that, in the determination at step S208, even when the position information of the information processing device 100 does not match the store position information acquired from the barcode 702, if a difference between the position information of the information processing device 100 and the store position information acquired from the barcode 702 is within a predetermined threshold range, processing may be proceeded with (step S210) similarly to when the two sets of information match. Setting of the threshold may be different depending on the store, and thus the threshold information may be included in the barcode 702.

On the other hand, when the barcode 702 is not included within the image at step S204, when there is no virtual RW declaration information in the barcode 702 at step S206, or when the GPS information does not match the store position information at step S208, the processing advances to step S222. At step S222, the image captured by the camera portion 110 is displayed on the display portion 112 as it is. Thus, in this case, CG of the virtual reader/writer 210 is not displayed.

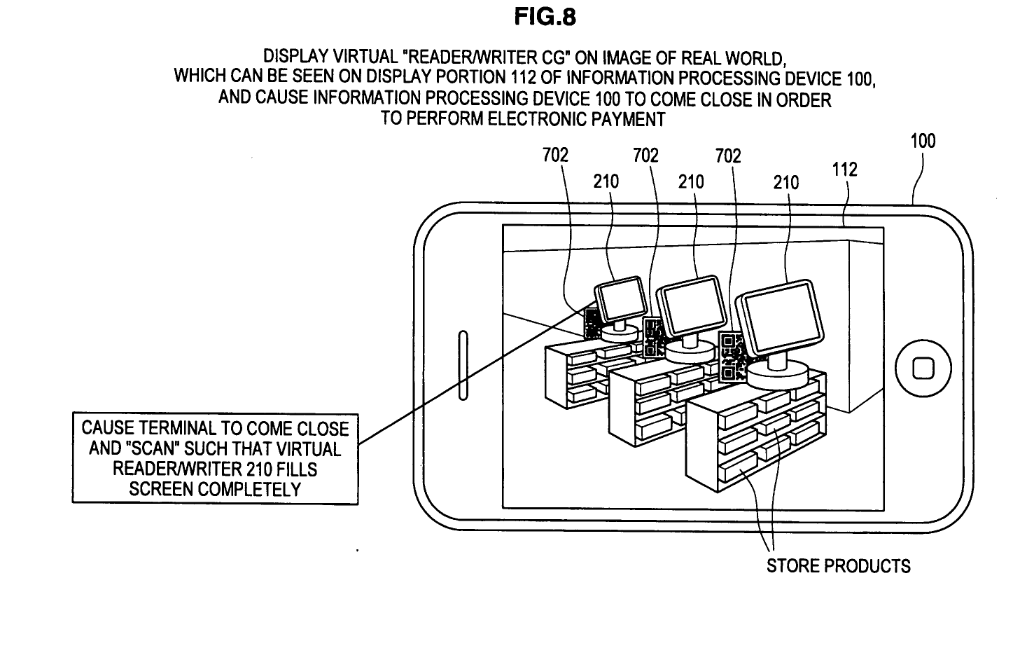

FIG. 8 is a schematic diagram showing a state in which CG of the virtual reader/writer 210 is merged with an image captured by the camera portion 110 and displayed on the display portion 112. As an example, as shown in FIG. 8, the virtual reader/writer 210 is displayed superimposed on top of the barcode 702 that is attached to the product 700. Further, FIG. 8 schematically depicts the manner in which, as the information processing device 100 comes closer to the product 700 (the barcode 702), the virtual reader/writer 210 and the barcode 702 in the background become progressively larger.

After step S210, using threshold values that have been set in advance, it is determined whether or not a distance between the virtual reader/writer 210 and the information processing device 100 has become extremely close and whether or not an orientation of the virtual reader/writer 210 is to the front as seen from the information processing device 100 (step S212). The determinations can be made by the position acquisition portion 124 of the CPU 120. 10 cm is one common standard used as the threshold value to determine whether or not the distance between the virtual reader/writer 210 and the information processing device 100 has become extremely close. This is the standard generally used as the specification for a non-contact IC card (FeliCa (registered trademark)). Further, when zero degrees is a case in which the lens of the camera portion 110 of the information processing device 100 is directly facing the front of the virtual reader/writer 210, an angle of tolerance of approximately ±15 degrees can be used as the threshold value for the orientation. Here, in the FeliCa (registered trademark) specification, in accordance with communication characteristics between the information processing device 100 and the real reader/writer 200, communication is started when the two parties come within a communicable distance (approximately within 10 cm, though this depends on communication characteristics of solid objects) and payment is made. Thus, also in a case when payment is made using the virtual reader/writer 210, by setting the distance between the information processing device 100 and the virtual reader/writer 210 at which payment is started to be the same as that of the FeliCa (registered trademark) specification, the user can perform payment with the same perception as when performing payment using the real reader/writer 200.

Note that 2D barcodes are generally rectangular in shape, and are characterized by having markers for recognition in 4 corners. In detecting the distance at step S212, the distance between the barcode 702 and the information processing device 100 is calculated based on the size of the barcode 702 and on the amount of these characteristics of the barcode 702. Also in detecting the orientation, a relative angle of the barcode 702 with respect to the information processing device 100 is calculated based on these characteristics of the barcode 702.

At step S212 shown in FIG. 8, the processing advances to step S214 when the distance between the virtual reader/writer 210 (the barcode 702) and the information processing device 100 is smaller than the threshold value, and when the orientation is also equal to or less than the threshold value of the angle of tolerance. However, the processing may advance to step S214 when either one of the above conditions is satisfied.

At step S214, it is determined whether or not the status flag is “RW prepared”. When the status flag is “RW prepared”, the information processing device 100 connects to the payment server 300 and the information processing device 100 requests to make payment (step S216). The payment request can be made by the processing execution portion 126 of the CPU 120. The payment processing is thus performed, and execution of the payment is notified to the user by audio and images. At this time, audio indicating payment is output by the input/output portion 114 of the information processing device 100. Further, images indicating the payment are displayed on the display portion 112.

On the other hand, when the distance between the virtual reader/writer 210 (the barcode 702) and the information processing device 100 is smaller than the threshold value, or when the orientation of the information processing device 100 with respect to the virtual reader/writer 210 (the barcode 702) is determined not to be to the front, the processing advances to step S220. At step S220, the user is shown a CG display of the virtual reader/writer 210. In this way, as the user has been notified that the virtual reader/writer 210 to perform payment is close by, the status flag is set to “RW prepared” (step S220).

Further, when, at step 5214, the status flag is not “RW prepared”, but is “No RW”, the processing advances to step S222 and “Please move terminal away from RW” is displayed on the screen. After step S222, the processing returns to step S200.

Here, as the status flag immediately after activation at step S200 is set to “No RW”, when the processing up to step S214 is performed immediately after activation, it is determined at step S214 that the status flag is not “RW prepared”. In this case, the position of the virtual reader/writer 210 is extremely close to the information processing device 100 and the orientation is also to the front, but the barcode 702 is recognized immediately after the information processing device 100 has been activated. A case is therefore assumed in which the information processing device 100 is accidentally close to the position of the virtual reader/writer at the time of activation. In this type of case, the processing does not advance to step S216, but advances to step S222. At step S222, the user is urged to be careful by displaying on the screen “Please move terminal away from RW” and it is thus possible to prevent payment being made unintentionally by the user. The processing described here can be performed by the processing execution prevention portion 128 of the CPU 120.

If the user moves the information processing device 100 away from the virtual reader/writer 210 in accordance with the screen display, and after that, the series of processing is performed once more from the update of the position information of the terminal (step S202), when the processing advances to step S212 the next time, the conditions at step S212 are not satisfied. As a result, the status flag is set to “RW prepared” at step S220. After that, if the user moves the information processing device 100 close to the virtual reader/writer 210, the conditions at step S212 are satisfied and the processing advances to step S214. In this case, the status flag is “RW prepared” and thus, payment is made at step S216.

According to the above-described processing shown in FIG. 7, when the barcode 702 is analyzed and the virtual reader/writer 210 is present, payment can be made if the information processing device 100 comes close to the virtual reader/writer 210 and the orientation of the information processing device 100 is to the front of the virtual reader/writer 210. In addition, it is possible to avoid the payment processing if the barcode 702 is close by immediately after activation of the information processing device 100, and the orientation is also to the front. Note that the processing shown in FIG. 7 is performed by the CPU 120, and programs to cause the CPU 120 to perform the processing shown in FIG. 7 can be stored in the memory 116, the non-volatile memory 140 or an external storage medium.

It should also be noted that, in an environment in which more than one of the virtual reader/writers 210 (the barcodes 702) exist together, a case is assumed in which the barcode 702 can be mistakenly recognized, depending on a frame rate and processing speed etc. of the camera portion 110 of the information processing device 100. In order to prevent this type of situation, it may be verified before performing payment whether the barcode 702 that is recognized when the status flag is set to “RW prepared” is the same as the barcode 702 determined to be at a close distance at a time point immediately before payment.

In the above-described example, when detecting the orientation of the virtual reader/writer (the barcode 702) as seen from the information processing device 100, the orientation is detected by calculating a relative angle between the barcode 702 and the information processing device 100 based on characteristics provided in the barcode 702. Alternatively, the orientation of the virtual reader/writer 210 as seen from the information processing device 100 may be detected by a geomagnetism detection function of GPS. For example, taking as an operational rule that the front sides of all the virtual reader/writers 210 are facing to the North, a method may be adopted in which processing that can make payment is only performed when the information processing device 100 comes close to the virtual reader/writer 210 from the North (at that time, the information processing device 100 is facing South in the geomagnetism detection device).

7. Method of Payment Other than by Information Processing Device Coming Close to Barcode

In the present embodiment, it is not necessary to cause the distance between the information processing device 100 and the barcode 702 to become close in order to perform the payment (specific operation). For example, in addition to the barcode that represents the virtual reader/writer 210, a separate barcode maybe prepared that indicates “payment execution”, and the payment may be performed when it is recognized that the two barcodes are mutually close together.

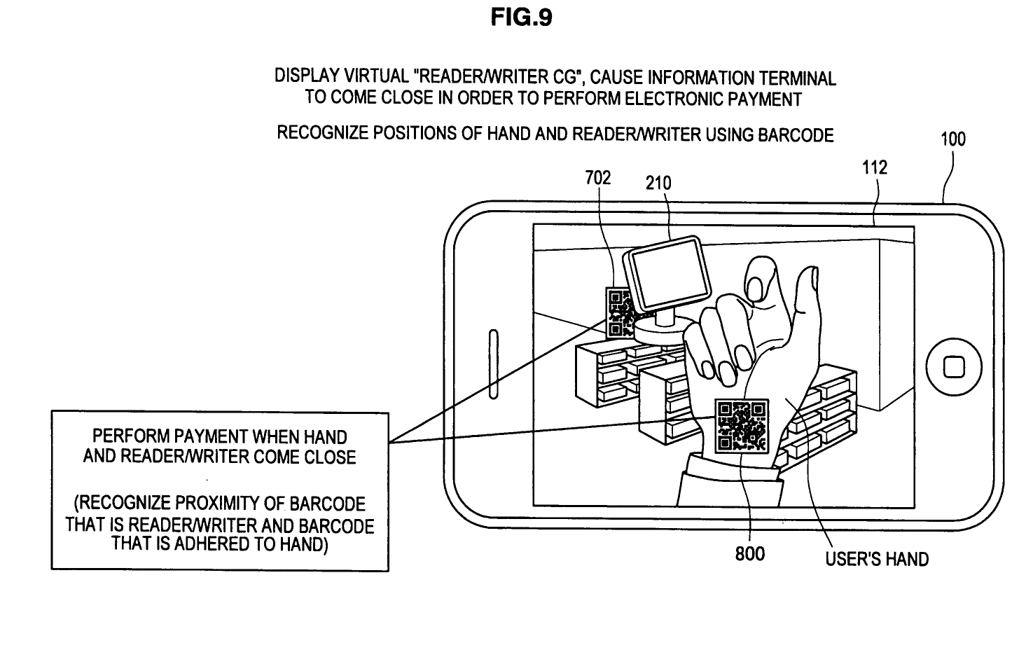

FIG. 9 shows a state in which a barcode 800 representing “payment execution” is attached to the user's hand, and both the barcode 702 and the barcode 800 are recognized as an image by the camera portion 110 and then displayed on the display portion 112. From the image of the barcode 702 and the barcode 800, the CPU 120 of the information processing device 100 recognizes the positions of both, and calculates a distance between the barcode 702 and the barcode 800. Then, payment processing is performed when the distance between the barcode 702 and the barcode 800 becomes equal to or less than a predetermined threshold value. In this way, usability is offered such that payment is performed based on simply moving the hand close to the product.

In the example shown in FIG. 9, a case is particularly effective in which the information processing device 100 takes the form of glasses that are worn by the user, and the display (of the image captured by the camera portion 110, and CG of the virtual reader/writer 210 and so on) of the display portion 112 is constantly perceived by the eyes of the user. In this case, the user can perform payment easily, by moving his or her hand, to which the barcode 800 is attached, close to the product to which the barcode 702 is attached.

In the case of the example shown in FIG. 9, the processing at step S212 in the processing flow shown in FIG. 7 is changed to: “The two barcodes 702 and 800 are extremely close.” Further, mistaken payment can be avoided by not performing payment when the barcode 702 and the barcode 800 are in positions extremely close to each other immediately after activation of the information processing device 100.

According to the above-described embodiment, the information processing device 100 starts specific processing by being placed in a specific position. Further, even if the information processing device 100 is placed in the specific position that satisfies conditions immediately after activation of the information processing device 100, the processing is not started until the information processing device 100 has once been moved away from the specific position and is once more caused to come close to the specific position. Thus, it is possible to prevent the processing being started without the intention of the user.

In addition, as a sense of operation can be realized in which the information processing device 100 is caused to come close to the virtual reader/writer 210, it is possible to offer usability in which payment is performed without the user being aware of a difference to the system in which the user performs payment by causing a normal non-contact IC card to come close to the real reader/writer 200.

For that reason, when the information processing device 100 has the built-in IC chip 102, in addition to payment by the above-described virtual reader/writer 210, payment can also be performed in a store that has already adopted a payment system in which the real reader/writer 200 is used. The user can therefore perform payment without any awareness of a difference in the systems.

Further, according to the present embodiment, through the action of “come close to the virtual reader/writer 210”, it can be confirmed that the user has a firm intention to purchase and pay for a specific product without any troublesome operation.

Further, according to the present embodiment, the user can perform payment by him/herself and thus the effort and waiting time to pay at the store can be omitted. At the same time, it is possible to use the shoplifting prevention gate 600 to prevent unpaid for products being removed from the store.

In addition, it is not necessary for the information processing device 100 to have the built-in IC chip 102, and it is also not necessary for the store to install the real reader/writer 200, thus reducing hardware costs in particular, and allowing easy introduction of a payment system.

Furthermore, by using a plurality of pieces of position information, such as the position of the store, a detailed position of the information processing device 100 that is obtained from the distance from the barcode 702, and the GPS position information etc., it is possible to improve the accuracy of the position information, and thus verify that the barcode 702 is correctly placed in the store. As a result, mistaken operation and mistaken payment can be prevented in advance. In addition, if the store position and the detailed position of the product are identified, for example, using one piece of position information obtained by GPS, when it is wished to change a position or a number of the virtual reader/writers, such as when increasing products, it is necessary to register that position information each time with the payment server 300. According to the present embodiment, it is easy to change the position and number of the virtual reader/writers 210 in the store.

The exemplary embodiment of the present embodiment is described above in detail with reference to the appended drawings. However, the present invention is not limited to these examples. It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2010-9455 filed in the Japan Patent Office on Jan. 19, 2010, the entire content of which is hereby incorporated by reference.

What is claimed is:

1. An information processing device comprising:
an identification medium detecting portion that detects a specific identification medium;
a position acquisition portion that acquires information indicating a positional relationship between the identification medium and the information processing device;
a processing execution portion that executes specific processing when the information processing device is at a distance from the identification medium that is equal to or less than a predetermined value; and
a processing execution prevention portion that causes the specific processing not to be performed by the processing execution portion when the information processing device is at a distance from the identification medium that is equal to or less than the predetermined value immediately after an application relating to the specific processing is activated.

2. The information processing device according to claim 1, further comprising:
an own device position information acquisition portion that acquires position information of the information processing device,
wherein the processing execution portion determines whether to execute the specific processing based on position information included in the identification medium and on the position information of the information processing device.

3. The information processing device according to claim 1,
wherein the processing execution portion performs the specific processing in one of a case in which the information processing device is at a distance from the identification medium that is equal to or less than the predetermined value and a case in which a separate medium is at a distance from the identification medium that is equal to or less than a predetermined value.

4. The information processing device according to claim 1,
wherein the position acquisition portion includes a function to acquire a relative orientation of the information processing device with respect to the identification medium, and
wherein the processing execution portion executes the specific processing when the relative orientation of the information processing device with respect to the identification medium is equal to or less than a predetermined angle range, taking as a reference a state in which the information processing device is correctly facing the identification medium.

5. The information processing device according to claim 1, further comprising:
an image pickup portion that acquires an image,
wherein the identification medium detecting portion detects the identification medium from the image acquired by the image pickup portion, and
wherein the position acquisition portion acquires the information indicating the positional relationship between the identification medium and the information processing device based on the image of the identification medium acquired by the image pickup portion.

6. The information processing device according to claim 5,
wherein the identification medium is a two-dimensional barcode.

7. The information processing device according to claim 5, further comprising:
a virtual object merging portion that merges a virtual object generated based on the identification medium acquired by the image pickup portion with the image; and
a display portion that displays the merged image, in which the virtual object is merged with the image acquired by the image pickup portion.

8. The information processing device according to claim 1,
wherein the identification medium detecting portion detects the identification medium by one of character recognition, near field wireless communication and optical communication.

9. The information processing device according to claim 1,
wherein the specific processing is one of payment processing relating to an object to which the identification medium is attached and payment processing relating to a store in which the identification medium is placed.

10. The information processing device according to claim 9, further comprising:
a payment processing notification portion that outputs one of image and audio when the payment processing is performed.

11. The information processing device according to claim 9, further comprising:
an IC chip that stores electronic value information relating to the payment processing.

12. An information processing system comprising:
an information processing device including
an identification medium detecting portion that detects a specific identification medium,
a position acquisition portion that acquires information indicating a positional relationship between the identification medium and the information processing device,
a processing request portion that, when the information processing device is at a distance from the identification medium that is equal to or less than a predetermined value, transmits identification information of the information processing device and information of the identification medium and requests to perform payment processing, and
a processing execution prevention portion that causes the processing request not to be performed by the processing request portion when the information processing device is at a distance from the identification medium that is equal to or less than the predetermined value immediately after an application relating to the payment processing is activated; and
a payment server that receives the request to perform the payment processing from the information processing device, and executes the payment processing when the identification medium is registered by a store to which the payment is performed.

13. The information processing system according to claim 12, further comprising:
a store terminal that, when the payment processing is executed, receives identification information of the information processing device from the payment server and also receives identification information of a product relating to payment that is included in the identification medium; and
a gate that is installed in the store, and that acquires the identification information of the product and the identification information of the information processing device that are going to pass through the gate and transmits the acquired identification information to the store terminal, the gate only opening when the gate receives notification from the store terminal that the product is paid for.

14. A storage medium storing a computer program comprising instructions that command a computer to perform the steps of:
detecting a specific identification medium;
acquiring information indicating a positional relationship between the identification medium and an information processing device;
executing specific processing when the information processing device is at a distance from the identification medium that is equal to or less than a predetermined value; and
preventing execution of the specific processing when the information processing device is at a distance from the identification medium that is equal to or less than the predetermined value immediately after activation of an application relating to the specific processing.

15. An information processing method, comprising the steps of:
detecting a specific identification medium;
acquiring information indicating a positional relationship between the identification medium and an information processing device;
executing specific processing when the information processing device is at a distance from the identification medium that is equal to or less than a predetermined value; and
preventing execution of the specific processing when the information processing device is at a distance from the identification medium that is equal to or less than the predetermined value immediately after activation of an application relating to the specific processing.
